(19) United States
(12) Patent Application Publication
(10) Pub. No.: US 2013/0052401 A1
(43) Pub. Date: Feb. 28, 2013

(54) Recyclable air barrier building membrane

(71) Applicants: Leland D. Snyder, Gig Harbor, WA (US); Philip L. Johnson, Spring Lake, MI (US)

(72) Inventors: Leland D. Snyder, Gig Harbor, WA (US); Philip L. Johnson, Spring Lake, MI (US)

(73) Assignee: VaproShield, LLC

(21) Appl. No.: 13/137,607

(22) Filed: Aug. 30, 2011

(51) Int. Cl. B32B 7/02; B32B 5/02; D05C 17/00; B32B 33/00

(52) U.S. Cl. 428/96; 428/212; 428/215; 428/213

(57) ABSTRACT

A recyclable permeable building membrane comprising a base layer of recycled polyester material having a gram per square meter (gsm) weight ranging from about 120 gsm to about 200 gsm and a top layer of virgin polyester material bonded to said base layer having a gram per square meter weight ranging from about 20 gsm to about 80 gsm bonded to said base layer, said membrane being an air barrier and having a permeability of at least 65 perms.

### RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to a building wrap for wrapping the structural components of a building in order to protect the structural components and optional building sheathing from moisture and specifically relates to a building wrap which is constructed of 60% to 70% recycled polyester and has a high permeability while providing both a moisture barrier and an air barrier.

### BACKGROUND OF THE INVENTION

Buildings, both residential and commercial, typically have a frame structure, a sheathing over the frame structure, and an exterior building covering over the sheathing. Building wraps have been widely used in the construction of buildings. The building wraps are typically placed between the sheathing and the exterior building covering to serve as a moisture barrier by inhibiting water intrusion into the building. These building wraps can also help to prevent energy loss by inhibiting air intrusion into the building. Popular building wraps include Tyvek® Homewrap, available from DuPont, and Typar® Housewrap, available from BBA Fiberweb.

Water can sometimes get behind the exterior building covering through cracks in the exterior building covering or by the window and door joints. Also, moisture from the relatively warm interior of the building can penetrate through the sheathing and the building wrap and condense into water upon contacting the relatively cold exterior building cover. The water can become trapped between the building wrap and the exterior building covering, possibly causing water damage to the building. Also, trapped water can encourage growth of mold and mildew, as well as water damage.

Suitable moisture vapor permeable water resistive barriers for use as building wrap include various porous sheets, which include woven fabrics, such as sheets of woven fibers or nonwoven fabrics, such as flashspun plexifilamentary sheets, spunbond nonwoven sheets, spunbond-meltblown nonwoven sheets, spunbond-meltblown-spunbond (SMS) nonwoven sheets, felts and laminates of any of the above including laminates of nonwoven or woven fabrics or scrims and a moisture vapor permeable film such as microporous film, microperforated film or nonporous breathable film.

Microporous films are well known in the art, such as those formed from a mixture of a polyolefin (e.g., polyethylene) and fine particulate fillers, which is melt-extruded, cast or blown into a thin film and stretched, either mono- or biaxially to form irregularly shaped micropores which extend continuously through the thickness of the film. U.S. Pat. No. 5,955,175 discloses microporous films, which have nominal pore sizes of about 0.2 micrometer. Microporous films can be laminated to nonwoven or woven layers using methods known in the art such as thermal or adhesive lamination.

Suitable microporous sheets or film for use in building wraps are spunbonded or fibrous bonded polyolefin which are described in U.S. Pat. No. 3,532,589 issued Oct. 6, 1970 and U.S. Pat. No. 5,972,147 issued Oct. 26, 1999 and the preferred polyolefins are polyethylene and polypropylene. Other microporous sheets which can be used include oriented polymeric films described in U.S. Pat. No. 5,317,035 issued May 31, 1994 which uses ethylene propylene back copolymers. The films may be reinforced with various types of scrim material or may be laminated to other vapor permeable sheets or films.

Other permeable building sheets using adhesive are disclosed in U.S. Pat. No. 6,901,712 issued Jun. 7, 2005; U.S. Pat. No. 5,374,477 issued Dec. 20, 1994; and U.S. Pat. No. 5,593,771 issued Jan. 14, 1997.

Competitive products currently on the market are not manufactured with recycled content and are typically manufactured from virgin plastic with a polyolefin, polypropylene or polyethylene base. In such products, water vapor transmission/permeance is dramatically lower than that to the present invention In addition, a number of the products are not air barriers and they are not recyclable after the life of the product if they are a composite of various plastics.

Representative competitive moisture vapor permeable sheets are TYVEK®, COMMERCIAL WRAP™, a flash spun high density polyethylene, available from E.I. du Pont de Nemours and Company (Wilmington, Del.) having a moisture vapor transmission of 23 perms, WEATHERMATE®, a nonwoven, nonperforated polyolefin based wrap, available from the Dow Chemical Company (Lackin, Mich.) having a moisture vapor transmission of 6.7 perms, GREENGUARD®, a woven building wrap available from Pactiv Corporation (Lake Forrest, Del.) having a moisture vapor transmission of 15 perms and TYPAR®, a polypropylene spunbonded material building wrap, available from Fiberweb, Inc. (Old Hickory, Tenn.) having a moisture vapor transmission of 11.7 perms.

It would be advantageous to provide a building wrap to the industry with a higher moisture vapor transmission rate that would not trap water that gets between the sheathing and the exterior building covering of a building and also acts as an air barrier.

### SUMMARY OF THE INVENTION

The present invention is directed to a multiple layer building wrap primarily constructed of recycled polyester for wrapping the structural components and sheathing of a building in order to protect the structural components and sheathing from exterior moisture while providing a high water vapor permeability and providing an air barrier. The wrap membrane is a recyclable permeable building membrane comprising a base layer of recycled polyester material having a gram per square meter (gsm) weight ranging from about 120 gsm to about 200 gsm and a top layer of virgin polyester material having a gram per square meter weight ranging from about 20 gsm to about 80 gsm bonded to the base layer with the layered membrane having a water vapor permeability of about 75 to about 80 perms.

It is an object of the invention to provide a building membrane which combines the 3 R's of sustainability: Reduce, Reuse and Recycle.

It is another object of the invention to produce a building membrane which is made from 75 to 80% recycled polyester materials by weight.

It is still another object of the invention to produce a building membrane which can be recycled back into PET post consumer products.

It is yet another object of the invention to produce a building membrane which allows the amount of recycled materials used in construction to be determined in a building project.

It is another object of the invention to produce a building membrane which acts as an air barrier and has a perm rating of at least 75 perms.

It is yet another object of the invention to produce a building membrane which is an air barrier.

It is still another object of the invention to produce a building membrane which has a Class A fire rating.

It is another object of the invention to produce a building membrane that requires less energy for manufacturing using a recycled base of plastic.

It is still another object of the invention that the top layer component used in the membrane product is a thermoplastic monolithic polymer film.

The invention will be better understood and objects other than those set forth above will become apparent when consideration is given to the following detailed description thereof. Such description makes reference to the annexed drawings herein.

### BRIEF DESCRIPTION OF THE DRAWINGS

FIG. 1 is an enlarged cross-sectional view of the inventive building wrap membrane;

FIG. 2 is a cut-away perspective view of the inventive building wrap membrane of the present invention as applied to an exemplary building structure and cladding partially applied over the building wrap membrane;

FIG. 3 is a top plan section of the inventive building wrap applied to building structure of FIG. 2 with the cladding stripped away; and

FIG. 4 is a side view of the building wrap of FIG. 4.

### DETAILED DESCRIPTION OF THE INVENTION

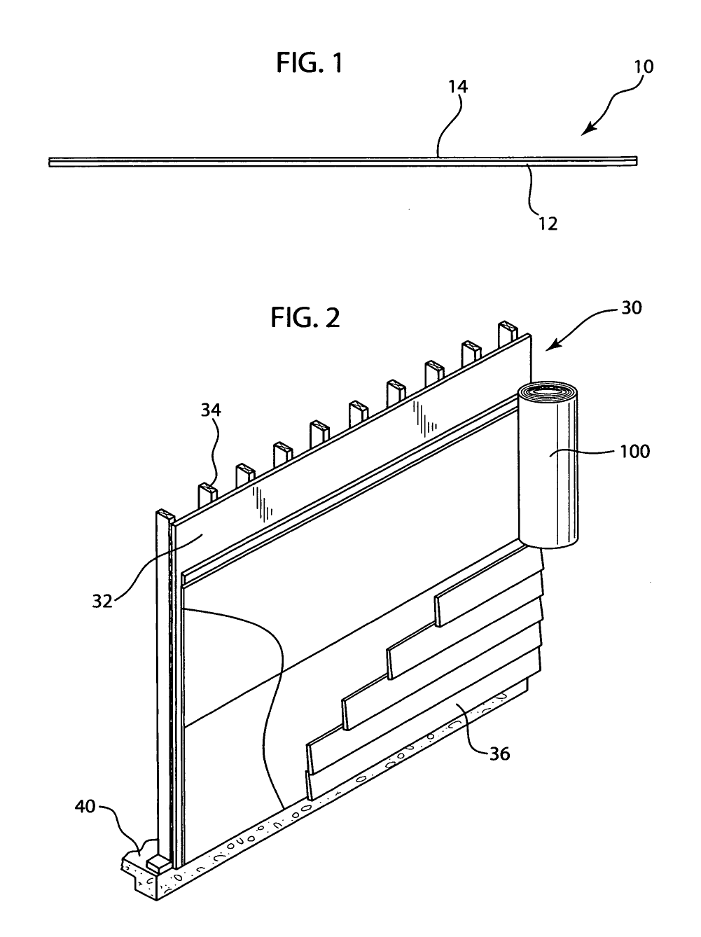

The preferred embodiments and best modes of the invention are shown in FIGS. 1 and 4. While the invention is described herein with regard to certain preferred embodiments, it is not intended that the present invention be so limited. On the contrary, it is intended to cover all alternatives, modifications, and equivalent arrangements as may be included within the spirit and scope of the invention as defined by the appended claims.

The present invention is a dual layered polyester membrane 10 formed of a recycled post consumer polyester material base layer 12 of needled manufactured fleece to provide strength and a carrier layer and a top layer of virgin polyester material 14 which is applied as a melted liquid extruded on the base layer 12. The base layer 12 is preferably PET (polyethylene terephthalate) plastic and the total volume by percentage of post consumer PET plastic used in the membrane is 60% to 70% by weight. The typical post consumer product used as the recycled material for the base layer 12 is recycled water or soft drink plastic bottles. The top layer 14 is a polymeric/monolithic film. Monolithic film is utilized instead of microporous film to achieve an air barrier permeable membrane 10. The membrane 10 reduces air flow in and out of the building envelope by 95% to 99%, thus saving energy. The building envelope formed by the membrane 10 is permeable, water resistant, an air barrier and 100% recyclable. The preferred base recycled material layer PET 12 has a gram per square meter (gsm) weight ranging from about 120 gsm to about 200 gsm and the top layer 14 is an extruded PET film applied as a liquid to the base layer and having a gram per square meter weight ranging from about 20 gsm to about 80 gsm with the total membrane 10 having vapor permeability ranging from about 50 to about 85 perms with the desired permeability being at least 65 perms. Permeability is important because it lets the building breathe allowing vapor to escape at a high rate verses being trapped in the wall assembly, thus preventing moisture buildup and mold and mildew. The composite product has a total weight of 210 gsm. The product thus offers LEED points from the U.S. Green Build Certification of a building.

In a more preferred embodiment of the dual layered polyester membrane, the base recycled polyester layer preferably has a gram per square meter (gsm) weight ranging from about 160 gsm to about 180 gsm and the top virgin polyester layer has a gram per square meter weight ranging from about 45 gsm to about 55 gsm with the total membrane having vapor permeability ranging from about 70 to about 80 perms.

In the most preferred embodiment of the dual layered polyester membrane, the base recycled polyester layer preferably has a gram per square meter (gsm) weight of about 170 gsm to about 180 gsm and the top virgin polyester layer has a gram per square meter weight of about 50 gsm with the total membrane having vapor permeability ranging from about 75 to about 80 perms.

In each of the above noted examples, the recycled polyester base layer 12 provides strength and serves as a carrier layer while the top virgin polyester layer is water resistant with a UV resistance and water vapor permeability ranging from between 50 and 80 perms. The membrane 10 provides 100% liquid water intrusion protection and provides air intrusion protection ranging from about 95% to about 99%. The base layer 12 has a thickness ranging from about 21 to about 22 mils and the top layer 14 has a thickness of about 2 mils for a total membrane thickness of 23 to 24 mils and a working ratio of 1:10.5 to 1:11.

The inventive building membranes 10 were tested and were water resistant and showed no leakage at 20 psi/100 mph wind driven rain. The preferred material for the base layer 12 is recycled PET polyester with the main source being plastic water bottles so that approximately 60% to 70% by weight of the membrane 10 is derived from post consumer recycled plastic and 15% to 25% by weight of the membrane is virgin polyester material, the same comprising the top layer 14. The entire membrane is 100% recyclable. Since the membrane 10 is air barrier membrane as it meets the requirement of ASTM 2178 and is Class A fire rated having passed ASTM E-84 requirements. The membrane also being an air barrier reduces air flow in and out of the building envelope by at least 95% thus saving energy. Since the membrane is more permeable than existing building membrane products it allows water vapor to escape at a high rate preventing the water vapor from being condensed and trapped in the wall assembly thereby causing building material degradation problems and health problems related to mold and mildew growth.

The following Tables show the test results for the most preferred embodiment of the dual layered polyester building membrane.

Table 1 is a dry tensile strength test run on the most preferred embodiment of the invention using ASTM D828 per AC38 requirements. Ten specimens were cut from the sample; five specimens were cut in the machine direction and five were cut in the cross machine direction measuring 1 inch by 10 inches from the sample material and conditioned in accordance with ASTM D685. The specimen was removed for conditioning, secured in the grips of a Satec T-5000 and load was applied to the specimens at a rate of 1-inch per minute. Maximum load was recorded as shown below.

TABLE 1
Dry Tensile Strength

| | | Load (lbf/in) | | | Pass/Fail | |
|---|---|---|---|---|---|---|
| Sample | Specimen | MD | XMD | AC38 Criteria | MD | XMD |
| VaproShield | 1 | 35.2 | 35.0 | ≧20 lbs/in | Pass | Pass |
| TWT | 2 | 38.6 | 36.3 | | | |
| | 3 | 44.1 | 36.6 | | | |
| | 4 | 38.7 | 39.4 | | | |
| | 5 | 44.0 | 27.1 | | | |
| | 6 | 34.2 | 39.8 | | | |
| | 7 | 36.5 | 36.4 | | | |
| | 8 | 43.7 | 36.6 | | | |
| | 9 | 44.5 | 40.2 | | | |
| | 10 | 34.3 | 35.6 | | | |
| | Average | 39.4 | 36.3 | | | |
| | Std. Dev.: | 4.3 | 3.7 | | | |

Table 2 is a dry breaking force test run on the most preferred embodiment of the invention using ASTM D5034-95 per AC38 requirements. Ten specimens were cut from the sample; five were cut in the machine direction and five were cut in the cross machine direction measuring 4 inches by 6 inches from the sample material and conditioned in accordance with ASTM D5034-95. Each specimen was removed for conditioning, secured in the grips of a Satec T-5000 and load was applied to the specimens at a rate of 12-inches per minute. Maximum load was recorded as shown below.

TABLE 2
Dry Breaking Force

| | | Load (lbf/in) | | | Pass/Fail | |
|---|---|---|---|---|---|---|
| Sample | Specimen | MD | XMD | AC38 Criteria | MD | XMD |
| VaproShield | 1 | 120.9 | 123.5 | MD ≧ 40 | Pass | Pass |
| TWT | 2 | 119.1 | 96.5 | XMD ≧ 35 | | |
| | 3 | 98.0 | 100.5 | | | |
| | 4 | 104.5 | 126.5 | | | |
| | 5 | 125.9 | 108.7 | | | |
| | Average | 113.7 | 111.1 | | | |
| | Std. Dev.: | 11.8 | 13.4 | | | |

Table 3 is a water resistance test run on the most preferred embodiment of the invention using AATCC 127/AC38 requirements. Three specimens were prepared from the supplied material after exposure to the following conditions: Control: Minimum 4 hours prior to testing at 70°. Weathered: Ultraviolet light per AC38 Section 4.1.2 (10 hours per day for 21 days), followed by Accelerated Aging per AC38 Section 4.1.3 (25 cycles where each cycle consists of 3 hours oven drying at 120° F., 3-hours immersion in water and 18-hours at 75° and 50% RH).

The specimens were secured in a testing apparatus and a 55 cm (22 inch) head of water was placed upon the specimens and maintained at a temperature of 70° and 65% relative humidity for 5 hours.

TABLE 3
Water Resistance

| | | Test | | | Pass/ |
|---|---|---|---|---|---|
| Specimen | Condition | No. | Observation | AC38 Criteria | Fail |
| VaproShield | Control | 1 | No Leakage | No Leakage | PASS |
| TWT | | 2 | No Leakage | | |
| | | 3 | No Leakage | | |
| | Weathered | 4 | No Leakage | No Leakage | PASS |
| | (AC38, 4.1) | 5 | No Leakage | | |
| | | 6 | No Leakage | | |

Table 4 is a water vapor transmission test run on the preferred embodiment of the invention using ASTM E96 per AC38 Table 3. Three specimens were prepared from the supplied material for each test. The specimen was sealed to the open mouth of a test dish filled with water or desiccant and placed in a test chamber in accordance with ASTM E96 for the duration of the test, the temperature and humidity of the chamber remain constant at 73° F. and 50% relative humidity, respectively. The dish assemblies were periodically weighed to determine the amount of water vapor released from or taken into the cup through the specimen. The AC38 criteria for water-vapor transmission of water resistive barriers is broken down by the “Grade” of the material as follows. The grading goes back to the UBC 14-1 standard entitled Kraft Waterproofing Building Paper.

| | | WVT Criteria |
|---|---|---|
| Grade | Definition | (grams per m2 per 24 hours) |
| A | High water-vapor resistance | Maximum 4 |
| B | Moderate water-vapor resistance | Maximum 6 |
| C | Water-resistant | NO CRITERIA |
| D | Water-vapor permeable | Minimum 35 |

TABLE 4
Test Results - ASTM E 96, Wet Cup

| | | WVT and Permeance | | | |
|---|---|---|---|---|---|
| | | English Units | | SI Units | |
| | | WVT | | WVT | |
| | | (grains/ | Permeance | (grams/m²- | Permeance |
| Specimen | Test | hr-ft²) | (perms) | 24 hrs) | (g/h-m²-PA) |
| VaproShield | 1 | 30.6 | 77.8 | 512.6 | 0.016 |
| TWT | 2 | 29.7 | 75.3 | 496.5 | 0.016 |
| | 3 | 30.4 | 77.1 | 508.4 | 0.016 |
| | Average | 30.2 | 76.7 | 505.8 | 0.016 |

A review of the data by an independent Laboratory indicate that the most preferred embodiment meets ICC-ES AC38 requirements for a Grade D water-resistive barrier and that the most preferred embodiment is compliant with requirements set forth in AC38, Section 3.4.

Table 5 is an air permeance test run on the preferred embodiment of the invention using ASTM 2178 three 4×4 foot (1.2 m×1.2 m) specimens were prepared from the supplied material and conditioned for a minimum period of seven (7) days at 73° and 50% relative humidity. A pressure differential was created across the specimen using a vacuum motor. The pressure difference was incrementally increased and for each pressure difference a reading was taken of the air flow rate. Data points were tabulated, graphed and an air permeance was derived. The samples were tested and the average air permeance at 75 Pascals pressure was calculated.

TABLE 5
Test Results, Air Permeance

| | | Sample Calculated | | | | |
|---|---|---|---|---|---|---|
| | Pressure | Measured Flow (L/s-m²) | | | Average | |
| Specimen | Pa (psf) | 1 | 2 | 3 | L/s-m² | cfm/ft² |
| VaproShield | 25 (.52) | 0.0012 | 0.0003 | 0.0007 | 0.0007 | 0.0001 |
| TWT | 50 (1.04) | 0.0003 | 0.0006 | 0.0022 | 0.0010 | 0.0002 |
| | 75 (1.57) | 0.0001 | 0.0003 | 0.0007 | 0.0004 | 0.0001 |
| | 100 (2.09) | 0.0000 | 0.0000 | 0.0007 | 0.0003 | 0.0001 |
| | 150 (3.13) | 0.0000 | 0.0001 | 0.0004 | 0.0002 | 0.0000 |
| | 300 (6.27) | 0.0000 | 0.0000 | 0.0003 | 0.0001 | 0.0000 |

| | | |
|---|---|---|
| Average: | 0.0005 | 0.0001 |

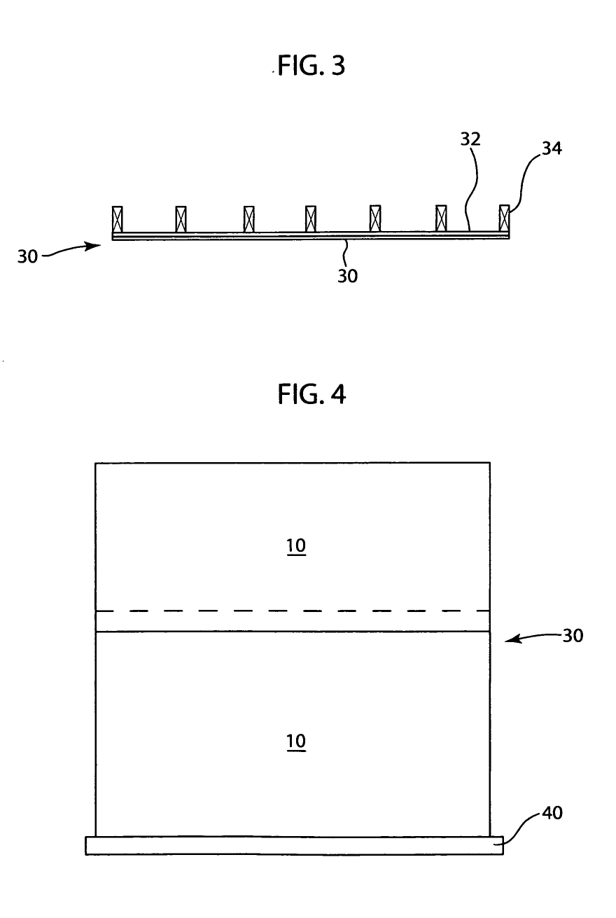

In construction application, as seen in FIGS. 2 to 4, a plurality of membrane sheets 10 are fastened to the sheeting 32 which is mounted on studs 34 of the building wall 30. The studs 34 are in turn nailed or fastened to flooring 40. The membrane sheets 10 are in the form of rolls of material 100 and are fastened to the sheeting 32 by fasteners such as staples, tacks, adhesives and the like and overlap each other 6 inches as seen in FIG. 4. After fastening, the membrane sheets 100 to the sheeting 32, an outside cladding 36 is mounted over the membrane sheets 10 in the standard manner presently used in construction.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A recyclable permeable building membrane comprising a base layer of recycled polyester material having a gram per square meter (gsm) weight ranging from about 120 gsm to about 200 gsm and a top layer of virgin polyester material bonded to said base layer having a gram per square meter weight ranging from about 50 gsm to about 80 gsm, said membrane being an air barrier and having a permeability of at least 65 perms.

2. A recyclable permeable building membrane as claimed in claim 1 wherein said base layer has a thickness ranging from about 21 to about 22 mils and said top layer has a thickness of about 2 mils.

3. A recyclable permeable building membrane as claimed in claim 1 wherein said base layer has a gram per square meter weight ranging from about 160 gsm to about 180 gsm and said top layer has a gram per square meter weight ranging from about 70 gsm to about 80 gsm.

4. A recyclable permeable building membrane as claimed in claim 3 wherein said base layer has a gram per square meter weight of about 170 gsm and said top layer has a gram per square meter weight of about 80 gsm.

5. A recyclable permeable building membrane as claimed in claim 1 wherein said base layer is recycled PET polyester and said top layer is an extruded film of virgin PET polyester, said layers being bonded together.

6. A recyclable permeable building membrane as claimed in claim 1 wherein the total volume of recycled polyester material used in the membrane ranges from about 60% to about 70%.

7. A recyclable permeable building membrane as claimed in claim 6 wherein said recycled polyester material is polyethylene terephthalate in the form of needled fleece.

8. A recyclable permeable building membrane as claimed in claim 1 wherein said recycled polyester material is obtained from PET polyester water bottles.

9. A recyclable permeable building membrane as claimed in claim 1 wherein said membrane has a permeability ranging from about 65 perms to about 80 perms.

10. A recyclable permeable building membrane as claimed in claim 9 wherein said membrane has a permeability of about 75 perms.

11. A recyclable permeable building membrane as claimed in claim 1 wherein said membrane is 100% recyclable.

12. A recyclable permeable building membrane as claimed in claim 1 wherein said membrane has a Class A fire resistance.

13. A recyclable permeable building membrane as claimed in claim 1 wherein said membrane is an air bather and a water barrier.

14. A recyclable permeable building membrane as claimed in claim 1 wherein said base and top layers are bonded together by heat.

15. A recyclable permeable building membrane comprising a base layer of recycled polyester material having a gram per square meter (gsm) weight ranging from about 160 gsm to about 180 gsm and a top layer of film composed of virgin polyester material having a gram per square meter weight ranging from about 65 gsm to about 80 gsm bonded to said base layer, said building membrane having a permeability ranging from about 70 perms to about 80 perms while functioning as an air barrier.

16. A recyclable permeable building membrane as claimed in claim 15 wherein said base layer has a gram per square meter weight of about 170 gsm and said top layer has a gsm weight of about 80 gsm.

17. A recyclable permeable building membrane as claimed in claim 15 wherein said membrane is 100% recyclable.

18. A recyclable permeable building membrane as claimed in claim 15 wherein said membrane has a permeability of about 75 perms.

19. A recyclable permeable building membrane as claimed in claim 15 wherein said membrane is at least 95% effective as an air barrier and is also effective as a water barrier.

20. A recyclable permeable building membrane comprising a base layer of recycled PET polyester processed as needlepoint manufactured fleece having a gram per square meter (gsm) weight of about 170 gsm and a top layer of extruded liquid virgin monolithic film of polyester having a gram per square meter weight about 80 gsm and a thickness of about 2 mils, the ratio of the thickness of said top layer to said base layer ranging from about 1:10 to about 1:11, said membrane having a permeability of about 75 perms to about 78 perms.
